(19) United States
(12) Patent Application Publication
(10) Pub. No.: US 2009/0006232 A1
(43) Pub. Date: Jan. 1, 2009

(54) Secure computer and internet transaction software and hardware and uses thereof

(76) Inventors: Ken A. Gallagher, Corona, CA (US); Michael McCarthy, San Juan Capistrano, CA (US)

Correspondence Address: BUCHALTER NEMER, 18400 VON KARMAN AVE., SUITE 800, IRVINE, CA, 92612, US

(21) Appl. No.: 11/824,270

(22) Filed: Jun. 29, 2007

(51) Int. Cl. G06Q 30/00

(52) U.S. Cl. 705/35

(57) ABSTRACT

Methods of using an alternate embedded browser object in conjunction with an ecommerce transaction software system are described that comprise providing a server; providing a client; providing a user; and utilizing a software application, a code, a password or a combination thereof for server and client authentication, wherein the software application, a code, a password or a combination thereof is based on the transaction type requested by the user at the time of use. Also described is an embedded browser object that interfaces to an ecommerce transaction system without the need for a keyboard.

### FIELD OF THE SUBJECT MATTER

The field of the subject matter is secure computer and internet transactions, including the software, media devices and hardware utilized for those transactions.

### BACKGROUND

Internet transactions have become commonplace in today's society in order to easily and conveniently conduct banking transactions, shop, update account and personal information for various retailers, banks and websites, correspond with other Internet users, etc. Unfortunately, Internet fraud and related identity theft is stifling the growth of banking and shopping applications on the Internet. Current conventional solutions to protect the customer are filled with faults that are exploited daily.

There are problems with current popular operating systems and browsers that were developed to give the end user as much utility as possible. Because of this across the board flexibility in order to provide more, these tools leave that same end user open for attack from different types of malicious programs such as spyware, adware, and viruses. Malicious programs like these are capable of tracking every keystroke on a keyboard, taking frequent screen shots of a user monitor, and then sending the information gathered to an outside source. Potentially, this outside source can have access to protected password and log-in information that can leave the customer a victim of identity theft or worse. Currently, almost all efforts are being focused on the bank or merchant side of these transactions, leaving the weakest link in the transaction chain as the customer.

For example, as reported in Computer Weekly, a popular technical periodical, computer hackers are inserting “malicious code,” spyware and/or viruses in computer networks in order to misappropriate seemingly secure information such as business plans, client files, personal information, account and banking information, passwords, etc. (http://www.computerweekly.com/Articles/2005/09/20/211879/Maliciouscodeattackse scalatingashackersworkforfinancialgain.htm and “New Phish Deceives With Phony Certificates” from TechWeb News). Key loggers that record all keystrokes on a computer or network are also a theft device of choice for many hackers. In addition, hackers and other computer criminals are using spam or “phishing” E-mails that are sent to Internet users and that include click through web addresses or fake self-signed digital certificates. These are ploys that take users to websites that give them the impression of being legitimate but are fronts for identity thieves. When an unsuspecting user clicks on the link provided in an E-mail, it will take the user to a parallel/dummy site that is similar to the official website. The dummy site requests that the user enter credit card, banking or i.d./password information and, if the user complies, confidential password and account information can be misappropriated. As spyware uses memory and system resources and the applications running in the background, it can lead to system crashes or general system instability. And because spyware exists as independent executable programs, it also has the ability to monitor keystrokes, scan files on the hard drive, snoop other applications such as chat programs or word processors, install other spyware programs, read cookies, and change the default home page on the Web browser and then relay this information back to the spyware author.

Software—such as antivirus software—has been developed in an attempt to minimize or eliminate the problems previously identified. However, antivirus software is only as effective as the last virus monitored. New viruses are rarely detected and stopped by conventional antivirus software. In addition, in order to conduct a complete virus scan of a computer, the user must wait several minutes while the software scans the hard drive. Antivirus software is also made less effective by the user. For example, if the user frequents gaming sites and other less secure sites, viruses, spyware and other software can be downloaded or used in real time to misappropriate user information without ever triggering the anti-virus software. Also, if the user clicks on links provided in phishing E-mails, the anti-virus software may be useless in combating future problems on the user's computer.

Websites, such as Paypal™, that ask for and catalog banking and personal information are also vulnerable to hacking without the individual user doing anything wrong. Large packets of information can be stolen, infected or otherwise misappropriated by hackers and computer thieves.

Although banks advertise secure banking, no matter what precautions they take on their side, the customers' computer is potentially the weakest link. The majorities of customers are unaware of the potential hazards of spyware viruses and are not educated as to how to protect their computers from all known threats. Chances are that most computer users already have a number of spyware viruses residing in their operating system. Because of all the current press on the dangers of spyware, most customers have chosen to discontinue online banking, yet online banking is considered pivotal for the future profitability of banking institutions. Online banking equals lower cost for banks and lower fees for consumers. Today, banks continue to recognize the expense of a personal interaction with the customer, and most banks have started charging for this cost of doing business.

All of the known and unknown dangers of using the Internet have led many consumers to reject using the Internet for anything more than an information source. Users concerned about losing personal information may choose to do their banking and shopping at conventional brick and mortar sites as opposed to conducting their business on the Internet. This choice by many potential Internet consumers defeats one of the ultimate purposes of the Internet: to provide a portal where consumers and businesses can come together without concern of location. In other words, someone in California can shop online at a local store in North Carolina without traveling to North Carolina. Businesses and banks can become more convenient and cost-effective for consumers

Therefore, in order to bring consumers together with banks and businesses in a secure Internet environment, software, media storage devices and/or hardware should be developed that a) provides a safe site for conducting financial transactions without contamination from viruses, phishing attempts, spyware, etc; b) provides software for accessing the secure site; c) provides updates to software in a timely fashion; and d) provides individualized software tailored specifically to banks and merchants financial websites, such as Bank of America, Citibank, Schwab, Sears, First American Corp., AmeriQuest, etc.

### BRIEF DESCRIPTION OF THE FIGURES

FIG. 1 shows what a contemplated log-in screen hosted by a server would look like to the client after successful authentication of supplied media storage device by server and subsequent launch of embedded browser object.

FIG. 2 shows a flow chart of the embodiment shown in FIG. 1.

### SUMMARY OF THE SUBJECT MATTER

Methods of using an alternate embedded browser object in conjunction with an ecommerce transaction software system are described that comprise providing a server; providing a client; providing a user; and utilizing a software application, a code, a password or a combination thereof for server and client authentication, wherein the software application, a code, a password or a combination thereof is based on the transaction type requested by the user at the time of use.

Also described is an embedded browser object that interfaces to an ecommerce transaction system without the need for a keyboard.

### DETAILED DESCRIPTION

Now, new software has been developed that provides a secure system for transacting Internet commerce by limiting what the user can do with the operating system and the Internet browser, and by eliminating the ability to maliciously or illegally interfere. Media storage devices, such as USB Thumb drives or any portable media storage device, can be provided that contain a bootable, scaled down operating system capable of only recognizing the computer hardware and components necessary for providing the desired Internet connection. In some embodiments, another program included on the media storage device can be a self-executing browser that has the predetermined connection to a secure “Internet Protocol address” programmed into the source code. This code takes the user to the banking/financial institution or merchant that has distributed the software or that has subscribed to the use of the software. The user has no ability to direct the browser to any other website that may be insecure. Each media storage device contains an encrypted registration number embedded into the browser object that has been registered to the end user and will be part of the login formula to create the secure connection with the banking/financial institution or merchant that registered the end user.

Methods are disclosed of using an alternate embedded browser object in conjunction with an ecommerce transaction software system that contains the hardware and software for both server and slient authentication based on the transaction type requested by the user at the time of use. The solution will use a combination of pre-programmed user ID's in addition to encrypted challenge phrases from the client to the server and from the server to the client. In some embodiments, software and hardware for authentication includes the use of a pre programmed ID issued from the bank and merged with user data in conjunction with challenge phrases controlled by the issuing bank. Contemplated challenge phrases comprise, in some embodiments, using an image submitted by the user. In some embodiments, a user-supplied image is used as a visual backdrop on the merchant website for authentication. Specifically, methods of using an alternate embedded browser object in conjunction with an ecommerce transaction software system are described that comprise providing a server; providing a client; providing a user; and utilizing a software application, a code, a password or a combination thereof for server and client authentication, wherein the software application, a code, a password or a combination thereof is based on the transaction type requested by the user at the time of use. Also described is an embedded browser object that interfaces to an ecommerce transaction system without the need for a keyboard.

It is contemplated that the browser is restricted to pre-determined IP addresses for communications. It is also contemplated that the embedded browser object will self-configure and run on a specific computer only. Advantageously, the ecommerce transaction software system that includes a user/bank/merchant supplied media will render itself inoperable upon unauthorized use. In addition, an embedded browser object interfaces to an ecommerce transaction system without the need for a keyboard. In these embodiments, file level and transmission encryption is utilized. Also, cipher block chaining is also utilized in some embodiments.

Embodiments and examples described herein aim to secure the client side of these transactions while enabling the bank or merchant (from time to time referred to as Server) to improve security on their side. In effect, by establishing protocols on Client and Server sides, these embodiments eliminate the influence of any malicious programs that may reside on the Client's computer and create a direct secure connection with the merchant or bank that has distributed the program or has signed on to the use of the software that is distributed by a third-party source.

An additional side benefit of the program is the ability to confirm a true connection with the entity that distributed the program. This confirmation gives the end-user the ability to circumvent two highly publicized and prevalent threats. One is Phishing, were the user receives an e-mail or instant message asking them to click on a hyperlink that will take them to their banking institution to update their personal information. In Phishing, the hyperlink gives the impression that it will take the client to his/her bank when in fact it re-directs them to an IP address that has been made to look like the official log-in screen of the banking institution. Once the client inputs their personal information, the Phisher has the information needed to access that client's account. Secondly, there is “Pharming”. In Pharming scams, an infected computer has its stored IP address for the clients browser, such as the popular Internet Explorer from Microsoft, changed so that when the client clicks on one of his/her stored IP addresses, they are re-directed to a site with malicious intent as spelled out in the previous example. The end-user needs only install and run the invention to communicate with said institution and confirm that any request to update personal information or any messages of importance from their financial institution are legitimate.

The contemplated software described herein may be contained on any suitable media storage device, such as a CD Rom, memory sticks, USB flash drives, USB storage devices and/or any portable media with the ability to store data where one can control read and write options. The software is stored on media storage devices in order to eliminate the ability of viruses to contaminate the software and also for the convenience of the client. In some embodiments, the software will be provided on read-only CDRoms. In other embodiments, the software will be provided on read-only memory sticks or USB storage devices. These memory sticks or USB storage devices can be easily transported in pockets, pocketbooks, on key chains, etc. Read/write media storage devices and/or hard drives may be used as long as the write control function or file level encryption can eliminate any contamination from viruses, spyware and/or any of the other malicious programs, such as those described herein.

The software is functional on any computer site as long as the media device is compatible. In some embodiments, the computer site will contain a USB port which is compatible with USB storage devices. In other embodiments, the computer site will contain a CD Rom drive which is compatible with CD Rom media storage devices. In yet another embodiment the computer site will contain a memory card reader which is compatible with memory cards. With the advent of new portable media storage devices, these too may be used. The client may use any computer site with the software described herein, such as those found in Internet cafes, at home, in libraries, at work, in airports, or in any other public or private place.

In some embodiments, the software is enabled when the client inserts supplied media storage device in or alongside of the computer site. So, for example, if the client wants to initiate or complete a financial transaction online, the client will insert the supplied USB thumb drive or supplied media storage device into the computer sites USB port or compatible interface. If the computer site is running any of the most popular operating systems, it will acknowledge the supplied peripheral device and boot-up the embedded browser object. In some configurations it may be necessary for the client to select the program from a pop-up menu. On boot-up or selection of the program, the embedded browser object confirms the internet connection; if it is not present, a connection manager is launched to guide the client through the connection protocol for that computer site. On confirmation of a connection, the embedded browser object transmits a file level encrypted packet containing but not limited to a serial number registered to the client's device and a challenge phrase embedded onto the client's device at registration time to a pre-programmed and embedded IP address of the issuing server. On confirmation by the issuing server of a valid ID and initial challenge phrase, the server side transmits in return an encrypted packet authenticating the server. From this point, a secure connection is established and all exchange of data from client to server and from server to client will be secured through both file and transmission level encryption until termination of transaction. Once initial client to server and server to client authentication has been validated, the embedded browser object and GUI (Graphic User Interface) become visible on the clients screen along with a server side provided log-in screen unique to that client/media storage device. The server supplied log-in screen may include unique information provided by the client to assure the client of the authenticity of the server. Such information may include but is not limited to, a personal image that may be used as a transparent background drop, challenge phrase or question, last transaction, last log-in time and date, etc. As mentioned, the software and resulting secure website may be used to interact with banking and financial institutions. The client is now connected to his/her bank through the server supplied log-in screen; the bank/server has recognized the client and both may now continue with the transaction in a secure environment. The Client now views and confirms personal information supplied by server side log-in screen, and then enters PIN/Password into space provided. A mouse-click interface supplied in the GUI of Browser Unit can be used at this time to input Password/PIN for extra security against Key and Screen Loggers. Additional encryption may also be available through additional security devices embedded into the mouse-click interface.

At this time, the software provided may use: the clients PIN/Password, the USB devices Registration/Serial number, server supplied one-time challenge phrase and or any number of unique identifiers in an algorithm to create the password that is sent to server to gain access to the clients banking information. On confirmation of a password, the server sends back a new challenge phrase to be used in the next log-in, assuring an account screen where the client can then conduct his/her online banking in a secure environment. On completion of transactions the client logs-out, and the connection with server is terminated and the device is shut down and removed.

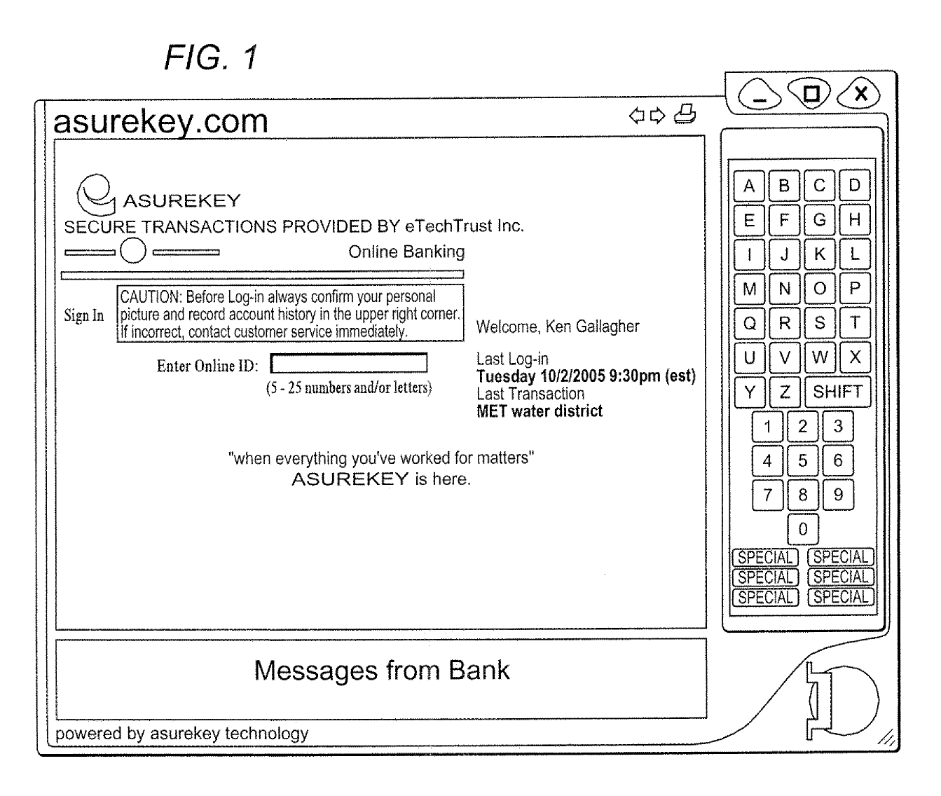

The application to an online e-commerce transaction will be described herein. FIG. 1 shows what a contemplated log-in screen hosted by a server would look like to the client after successful authentication of supplied media storage device by server and subsequent launch of embedded browser object. In FIG. 1, an embedded browser object (105) is shown, along with a GUI and mouse-click interface (110) of supplied media storage device (not shown), a log-in screen (120), a challenge phrase (not shown) and personal identifiers (140), which are supplied via the server side.

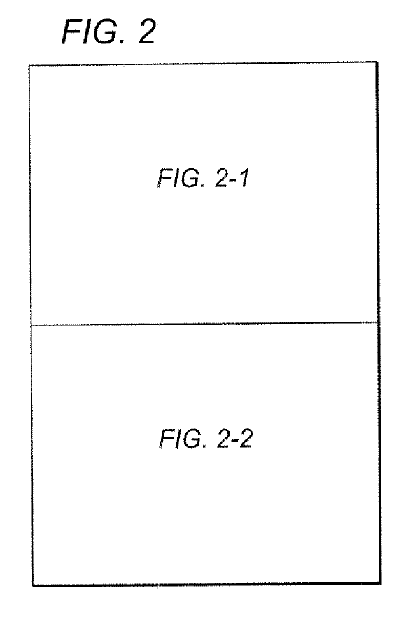

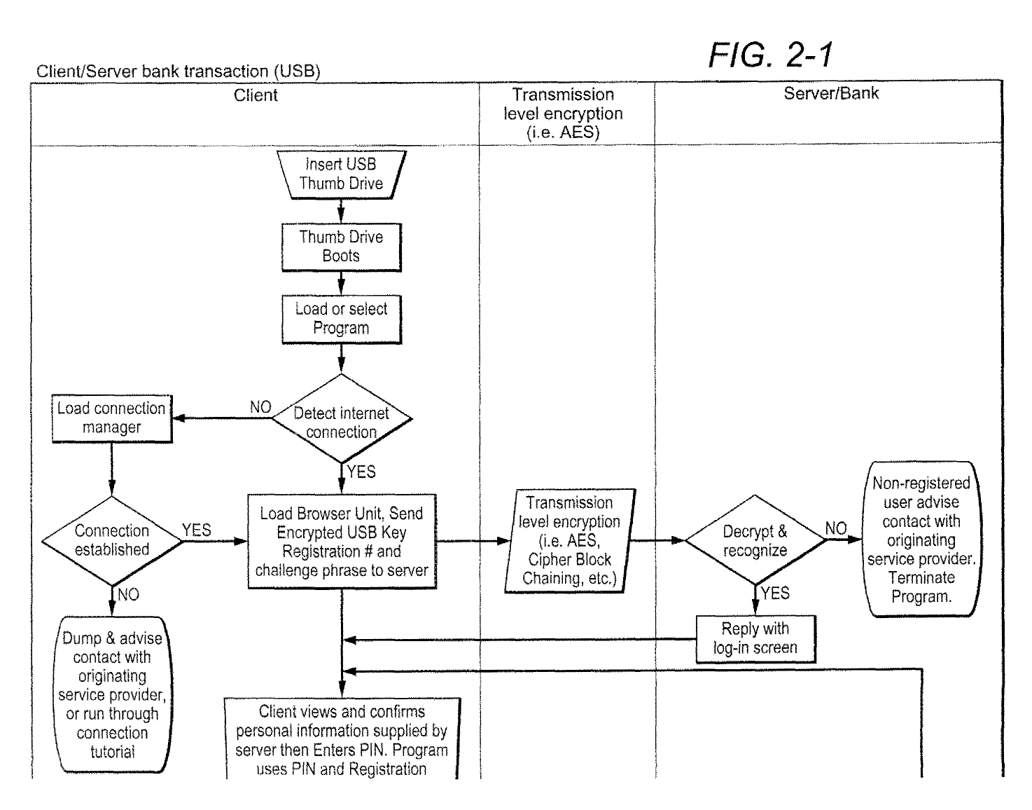

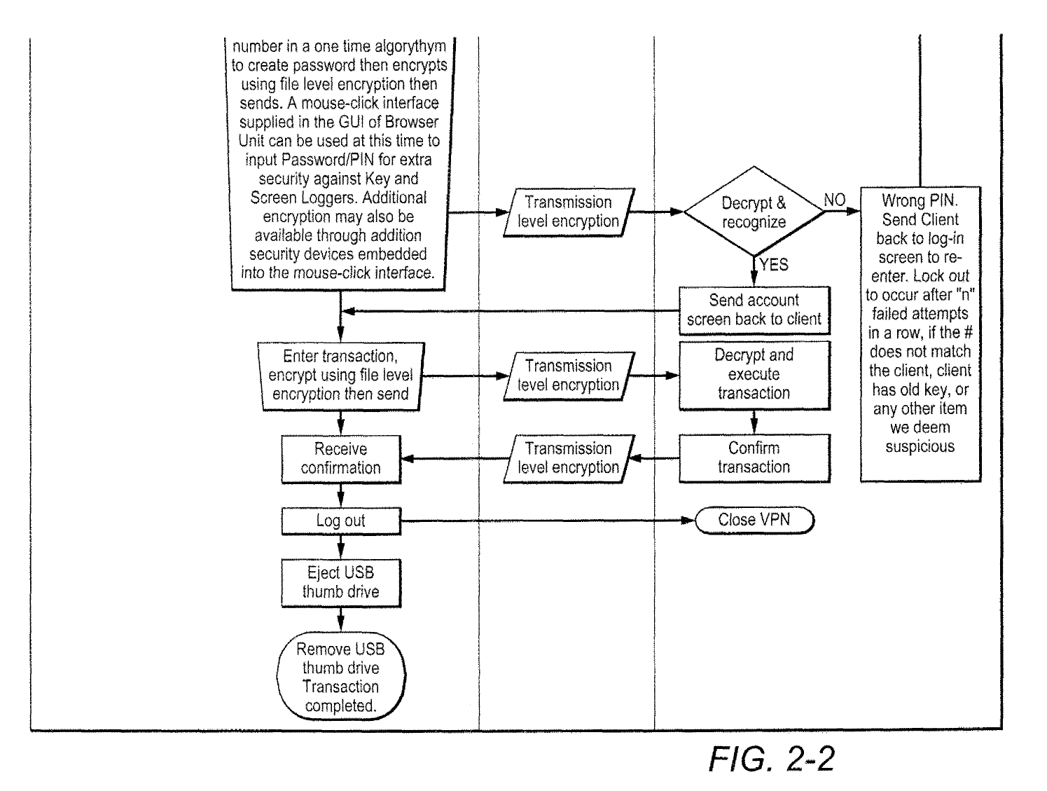

FIG. 2 shows a flow chart of the above embodiment of a client/server bank transaction (200) shown in FIG. 1. For this particular embodiment, a user on the client side (210) of the transaction inserts a storage media, such as a USB storage device (220). The drive is booted up (225) and the program for the transaction is selected and/or loaded (230). An Internet connection is established next (240) and a transmission level encryption (245) is set up in the communication between the client side (210) and the server/bank side (250). The client/user receives and responds to a series of identifier questions (260) in order to establish the proper identification of the proper user. The particular transaction is performed (270) and the user/client logs out or off of the system (280).

Thus, specific embodiments, methods of use and applications of secure computer and Internet software system with related storage and hardware have been disclosed. It should be apparent, however, to those skilled in the art that many more modifications besides those already described are possible without departing from the inventive concepts herein. The graphical interface presented to the user may vary from those graphical interfaces depicted in this subject matter without departing from the inventive concepts. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A method of using an alternate embedded browser object in conjunction with an ecommerce transaction software system, comprising:
providing a server;
providing a client;
providing a user; and
utilizing a software application, a code, a password or a combination thereof for server and client authentication, wherein the software application, a code, a password or a combination thereof is based on the transaction type requested by the user.

2. The method of claim 1, further comprising using a combination of pre-programmed user identifications in addition to encrypted challenge phrases from the client to the server and from the server to the client.

3. The method of claim 1, wherein the software application, the code, the password or the combination thereof includes the use of a pre programmed ID issued from a bank and merged with a set of user data in conjunction with at least one challenge phrase controlled by the bank.

4. The method of claim 3, wherein the at least one challenge phrase comprises using an image submitted by the user.

5. The method of claim 4, wherein the image is used as a visual backdrop on a merchant website for authentication.

6. The method of claim 1, wherein the browser is restricted to a set of pre-determined IP addresses for communications.

7. The method of claim 1, wherein the embedded browser object will self-configure and run on a particular computer.

8. The method of claim 1, wherein the ecommerce transaction software system will render itself inoperable upon unauthorized use.

9. An embedded browser object that interfaces to an ecommerce transaction system without the need for a keyboard.
